(19) United States
(12) Patent Application Publication
(10) Pub. No.: US 2012/0231651 A1
(43) Pub. Date: Sep. 13, 2012

(54) COMPONENT FIXING STRUCTURE

(75) Inventors: Manabu WAKAO, Kawasaki (JP); Kouichi Kuramitsu, Kawasaki (JP); Kenji Tsutsumi, Kawasaki (JP)

(73) Assignee: Fujitsu Limited, Kawasaki-shi, Kanagawa (JP)

(21) Appl. No.: 13/480,201

(22) Filed: May 24, 2012

Related U.S. Application Data
(63) Continuation of application No. PCT/JP2009/070595, filed on Dec. 9, 2009.

(51) Int. Cl. H01R 13/64; H01R 43/26

(52) U.S. Cl. 439/374; 29/825

(57) ABSTRACT

A plug of a connector includes plug-side electrode terminals arranged therein, the plug having a first engagement part on one end side in a direction of arrangement of the plug-side electrode terminals and a second engagement part on the other end side. A jack of the connector includes jack-side electrode terminals arranged therein, the jack having a third engagement part on one end side in a direction of arrangement of the jack-side electrode terminals and a fourth engagement part on the other end side. A guide member has a fifth engagement part and a sixth engagement part, the fifth engagement part configured to engage with the first engagement part of the plug and the third engagement part of the jack, the sixth engagement part configured to engage with the second engagement part of the plug and the fourth engagement part of the jack.

### CROSS-REFERENCE TO RELATED APPLICATIONS

This application is a U.S. continuation application, filed under 35 USC 111(a) and claiming the benefit under 35 USC 120 and 365(c), of PCT application JP2009/070595 filed Dec. 9, 2009. The foregoing application is hereby incorporated herein by reference.

### FIELD

The embodiment discussed herein is directed to connectors and a method of connecting the connectors.

### BACKGROUND

In recent years, densification in the device structures of electric devices or electronic devices has been progressed, while various kinds of functions are required for electric devices or electronic devices. Thus, the electric circuits and electronic circuits to be incorporated into the electric devices or the electronic devices have become complex. There are many cases in which two circuit boards are connected to each other or a function module is connected to a circuit board.

When connecting two circuit boards or connecting a function module to a circuit board, usually, a multi-pin connector having many pins is used. Generally, the multi-pin connector includes a plug and a jack (socket) so that the plug is fitted into the jack to achieve a mechanical connection and an electrical connection.

The multi-pin connector has directivity with respect to fitting of the plug and jack in many cases. The directivity in insertion and removal of the connector is determined by a direction of arrangement of the pins provided in the plug. For example, according to the connector having a directivity, the plug can be connected to the jack while slightly inclining the plug within a plane containing an extending direction of the pins and an aligning direction of the pins, but it is not desirable to connect the plug to the jack while inclining the plug in a direction other than the aforementioned direction. If an attempt is made to connect the plug to the jack while inclining the plug in a direction other than the direction within a plane containing extending direction of the pins and aligning direction of the pins, an excessive force may be applied to the pins, which may cause the pins to be bent or damaged.

Many connectors for connecting two circuit boards or connecting a functional module to a circuit board are mount-type connectors. Moreover, many mount-type connectors have a low height, which is referred to as a low-back type. That is, by using a connector having a low height, a distance between circuit boards connected to each other or a distance between a module and a board is reduced in order to increase a package density.

However, if the low-back type connector is used, there is a problem in that it is difficult to visually recognize the connector when connecting the connector. For example, if the connector is arranged in a middle portion of the circuit bard, the plug and the jack of the connector may be hidden in a position deep inside the space between the two circuit boards, which prevents the plug and the jack from being visually recognized easily. For this reason, the plug cannot be well-positioned relative to the jack, and there also may be a case where the plug cannot be connected according to the directivity of the connector. Similarly, in a case where a module is connected to a circuit board, the connector may be hidden in a space between the module and the circuit board, which prevents the plug and the jack from being visually recognized easily.

Thus, it is suggested in a Patent Document 1, for example, Japanese Laid-Open Patent Application No. H4-26084, to arrange a plug position correction tool around a jack to automatically guide the plug to a connecting position. The plug position connection tool is a member extending from a periphery of the jack toward a tip of the jack. The plug position correction tool is configured to have a structure in which a tip portion of the plug is first brought into contact with the plug position correction tool, and, then, the plug is guided to a position at which the plug is connected to the jack while the plug is slid along the plug position correction tool.

The plug position correction tool disclosed in the Patent Document 1 is capable of correcting the position in a range where the plug is very close to the jack, however, it cannot guides the plug to the position where the plug is very close to the jack (that is, to a position where a tip of the plug is brought into contact with the plug position correction tool). Thus, it is necessary to perform a connecting operation while visually recognizing the plug and the jack until the tip of the plug contacts the plug position correction tool. Accordingly, the problem that it is difficult to visually recognize the connector when connecting the connector still remains.

Moreover, the plug position correction tool disclosed in Patent Document 1 merely guide the plug to an accurate position, and the directivity of the connector is not taken into consideration. That is, because the plug position correction tool disclosed in Patent Document 1 cannot guide the plug along the connecting direction of the connector, there may be a case where an attempt is made to connect the plug to the jack in a wrong direction.

### SUMMARY

According to an aspect of the invention, a connector includes: a plug including a plurality of plug-side electrode terminals arranged therein, the plug having a first engagement part on one end side in a direction of arrangement of the plug-side electrode terminals and a second engagement part on the other end side; and a jack including a plurality of jack-side electrode terminals arranged therein, the jack-side electrode terminals configured to be connected to the plug-side electrode terminals, the jack having a third engagement part on one end side in a direction of arrangement of the jack-side electrode terminals and a fourth engagement part on the other end side; and a guide member having a fifth engagement part and a sixth engagement part, the fifth engagement part configured to engage with the first engagement part of the plug and the third engagement part of the jack, the sixth engagement part configured to engage with the second engagement part of the plug and the fourth engagement part of the jack.

The object and advantages of the embodiment will be realized and attained by means of the elements and combinations particularly pointed out in the appended claims.

It is to be understood that both the foregoing general description and the following detailed description are exemplary explanatory only and are not restrictive of the invention, as claimed.

### BRIEF DESCRIPTION OF DRAWINGS

FIG. 1 is a perspective view of a connector according to a first embodiment;

FIG. 2 is a side view of the connector according to the first embodiment;

FIG. 3A is a side view illustrating a state before a module is connected to a circuit board;

FIG. 3B is a perspective view illustrating a plug provided on the back surface of the module;

FIG. 3C is a perspective view of the plug and the guide member illustrated in FIG. 3B.

FIGS. 4A, 4B and 4C are views corresponding to FIGS. 3A, 3B and 3C, respectively, and illustrating a state where a second engagement axis is engaged with a second notch of the plug;

FIGS. 5A, 5B and 5C are views illustrating a state where a first engagement axis is engaged with a fourth notch of a jack;

FIG. 6 is a side view illustrating positions of the first and second engagement axes of a guide member in the stated illustrated in FIGS. 5a, 5B and 5C;

FIGS. 7A, 7B and 7C are views illustrating a state in the middle of moving the module toward the circuit board;

FIGS. 8A, 8B and 8C are views illustrating a state where an end surface of the plug reaches an end surface of the jack;

FIG. 9 is a side view illustrating positions of engagement axes of a guide member in the state illustrated in FIGS. 8A, 8B and 8C;

FIG. 10 is a side view illustrating positions of the engagement axes of the guide member in the middle of inserting the plug into the jack;

FIG. 11 is a side view illustrating positions of the engagement axes of the guide member in the middle of inserting the plug into the jack;

FIGS. 12A, 12B and 12C are views illustrating a state where the module is connected to the circuit board;

FIG. 13 is a side view illustrating positions of the engagement axes of the guide member in a state where the plug is completely inserted in the jack;

FIG. 14 is a perspective view of a connector according to a second embodiment;

FIG. 15 is a cross-sectional perspective view of the connector illustrated in FIG. 14;

FIGS. 16A and 16B are views illustrating a state where engagement axes of a relay guide member are engaged with notches of an engagement part of the plug;

FIGS. 17A and 17B are views illustrating a state where a relay connection part is stacked on the jack and the plug is further stacked on the relay connection part;

FIGS. 18A and 18B are views illustrating a state where the plug is pressed toward the jack through the relay guide member; and

FIGS. 19A and 19B are views illustrating a state where the plug is connected to the jack through the relay connection part.

### DESCRIPTION OF EMBODIMENT(S)

Preferred embodiment of the present invention will be explained with reference to the accompanying drawings.

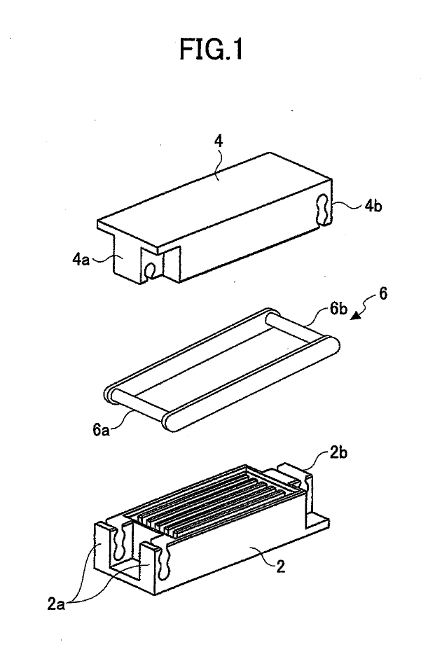

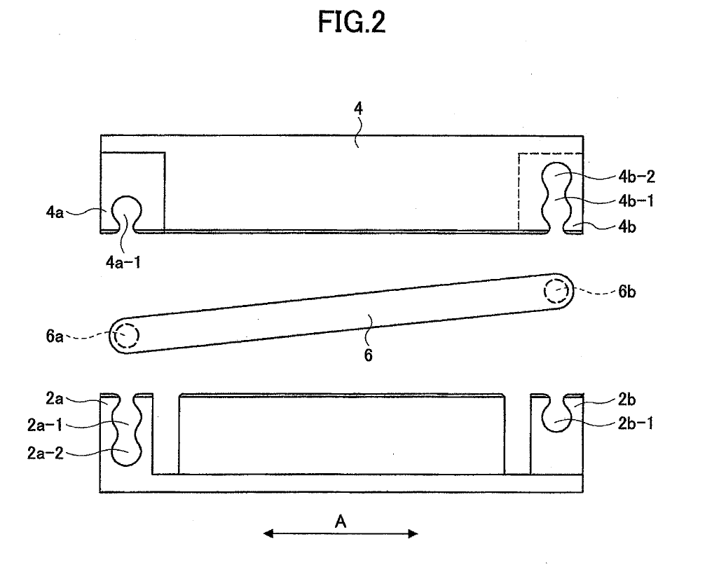

A description will now be given of a case where a connector according to the first embodiment is used as a connector for connecting a module to a circuit board. FIG. 1 is a perspective view of the connector according to the first embodiment. FIG. 2 is a side view of the connector according to the first embodiment. The connector illustrated in FIG. 1 and FIG. 2 is a so-called stack connector, which includes a jack and a plug 4 inserted in the jack 2. The connector according to the present embodiment further includes a guide member 6. The guide member 6 includes a first engagement axis 6a (fifth engagement part), which is engageable with an engagement part 2a (third engagement part) of the jack 2 and an engagement part 4a (first engagement part) of the plug 4, and a second engagement axis 6b (sixth engagement part), which is engageable with an engagement part 4b (second engagement part) of the plug 4 and an engagement part 2b (fourth engagement part) of the jack 2.

Many electrode terminals are arranged inside the plug 4. When the plug 4 is inserted into the jack 2, the electrode terminals provided in the plug 4 are brought into contact with electrode terminals provided in the jack 2, which achieves an electrical connection. In the jack 2 and the plug 4, the electrode terminals are arranged in a direction of arrow A of FIG. 2 so that, when positioning the plug 4 to insert into the jack 2, the plug 4 can be moved closer to the jack while inclining the plug 4 in the direction of arrow A.

The engagement part 2a of the jack 2 has a fourth notch 2a-1 and a fifth notch 2a-2 that are provided in the vicinity of an end of the connector (jack 2) in the direction of arrow A. Each of the fourth notch 2a-1 and the fifth notch 2a-2 is a notch having a generally circular shape having a diameter slightly larger than an outer diameter of the first engagement axis 6a of the guide member 6. The fifth notch 2a-2 is formed to connect to the fourth notch 2a-1. A width of a portion where the fifth notch 2a-2 is connected to the fourth notch 2a-1 is slightly smaller than the outer diameter of the first engagement axis 6a. Accordingly, the first engagement axis 6a of the guide member 6 can be brought into engagement with the fifth notch 2a-2 by pressing the first engagement axis 6a with a certain force in a state where the first engagement axis 6a of the guide member 6 is in engagement with the fourth notch 2a-1.

The engagement part 4a of the plug 4 has a first notch 4a-1 provided in the vicinity of an end of the connector (plug 4) in the direction of arrow A. The first notch 4a-1 is a notch having a generally circular shape having a diameter slightly larger than the outer diameter of the first engagement axis 6a of the guide member 6 and a width of an opening part of the first notch 4a-1 is slightly smaller that the outer diameter of the first engagement axis 6a. Accordingly, the first engagement axis 6a of the guide member 6 can be brought into engagement with the first notch 4a-1 by pressing the first engagement axis 6a against the opening part of the first notch 4a-1.

The engagement part 2b of the jack 2 has a sixth notch 2b-1 provided in the vicinity of the other end of the connector (jack 2) in the direction of arrow A. The sixth notch 2b-1 is a notch having a generally circular shape having a diameter slightly larger than an outer diameter of the second engagement axis 6b of the guide member 6 and a width of an opening part of the sixth notch 2b-1 is slightly smaller that the outer diameter of the second engagement axis 6b. Accordingly, the second engagement axis 6b of the guide member 6 can be brought into engagement with the sixth notch 2b-1 by pressing the second engagement axis 6b against the opening part of the sixth notch 2b-1.

The engagement part 4b of the plug 4 has a second notch 4b-1 and a third notch 4b-2 that are provided in the vicinity of an end of the connector in the direction of arrow A (a right end in FIG. 2). Each of the second notch 4b-1 and the third notch 4b-2 is a notch having a generally circular shape having a diameter slightly larger than the outer diameter of the second engagement axis 6b of the guide member 6. The third notch 4b-2 is formed to connect to the second notch 4b-1. A width of a portion where the third notch 4b-2 is connected to the second notch 4b-1 is slightly smaller than the outer diameter of the second engagement axis 6b. Accordingly, the second engagement axis 6b of the guide member 6 can be brought into engagement with the third notch 4b-2 by pressing the second engagement axis 6b with a certain force in a state where the second engagement axis 6b of the guide member 6 is in engagement with the second notch 4b-1.

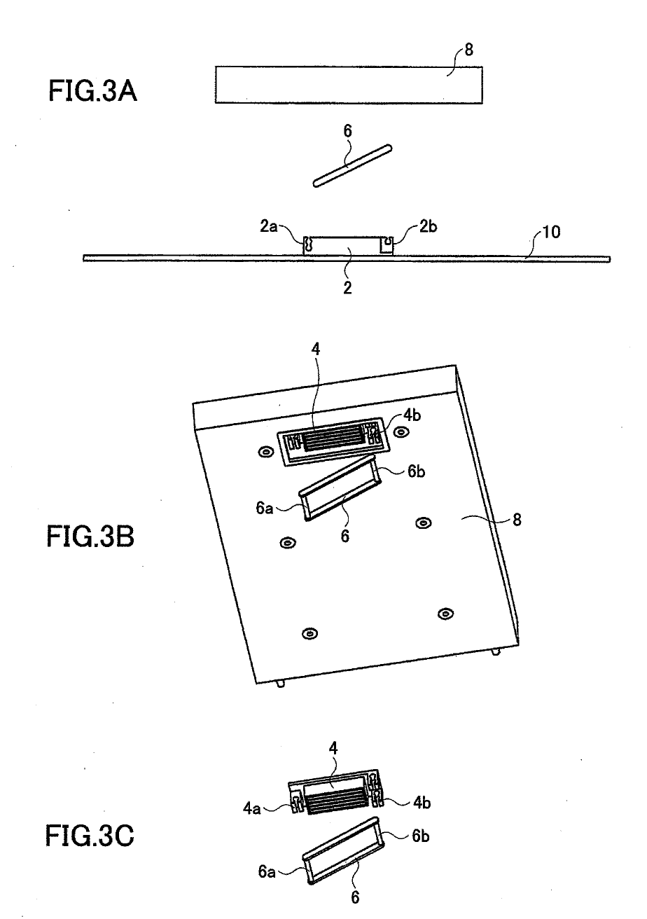

FIGS. 3A, 3B and 3C are views illustrating an example of connecting a module 8 to a circuit board 10 using the connector according to the present embodiment. FIG. 3A is a side view illustrating a state before the module 8 is connected to the circuit board 10. FIG. 3B is a perspective view illustrating the plug 4 provided on the back surface of the module 8. FIG. 3C is a perspective view of the plug 4 and the guide member 6 illustrated in FIG. 3B.

Because the plug 6 of the connector is embedded in the back surface of the module 8, the plug 6 does not appear in FIG. 3A. In FIG. 3A, the jack 2 of the connector mounted to the circuit board 10 is illustrated. In the state illustrated in FIG. 3A, the guide member 6 is has not yet attached to either of the plug 4 and the jack 2.

In FIG. 3A, in order to insert and connect the plug 4 of the module 8 to the jack 2 of the circuit board 10, the module 8 is moved closer to the circuit board 10 in the state where the plug 4 faces the jack 2. At this time, first, the second engagement axis 6b of the guide member 6 is pressed into and engaged with the second notch 4b-1 provided in the engagement part 4b of the plug 4.

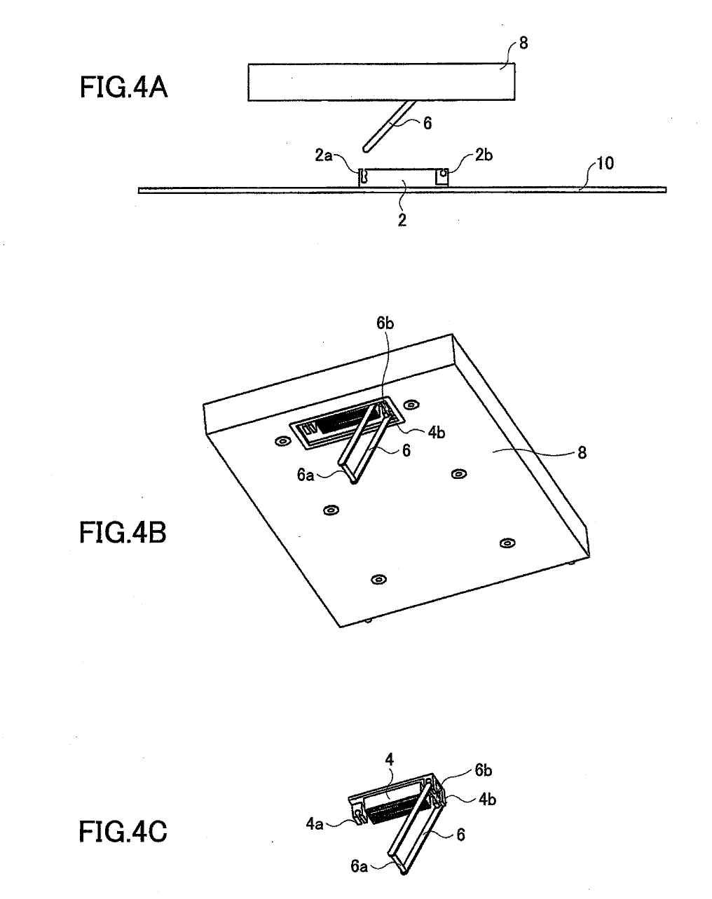

FIGS. 4A, 4B and 4C are views illustrating the state where the second engagement axis 6b is engaged with the second notch 4b-1 of the plug 4. FIGS. 4A, 4B and 4C are views corresponding to FIGS. 3A, 3B and 3C, respectively. As illustrated in FIG. 2, the second notch 4b-1 and the third notch 4b-2 are formed continuously. However, in the state illustrated in FIG. 3, the second engagement axis 6b is pressed into the position of the second notch 4b-1 and is not in engagement with the third notch 4b-2. The guide member 6 is set in a state where the guide member 6 hangs underneath the plug 4 in a state where the second engagement axis 6b is engaged with and supported by the second notch 4b-1. Accordingly, the first engagement axis 6a of the guide member 6 hangs from the back surface of the module 8, and the first engagement axis 6a of the guide member 6 can be visually recognized easily from an obliquely upward side of the module 8.

Thus, the first engagement axis 6a is pressed into the fourth notch 2a-1 provided in the engagement part 2a of the jack 2 to cause the first engagement axis 6a to be engaged with the fourth notch 2a-1 while visually recognizing the first engagement axis 6a of the guide member 6 that remarkably hangs from the back surface of the module 8.

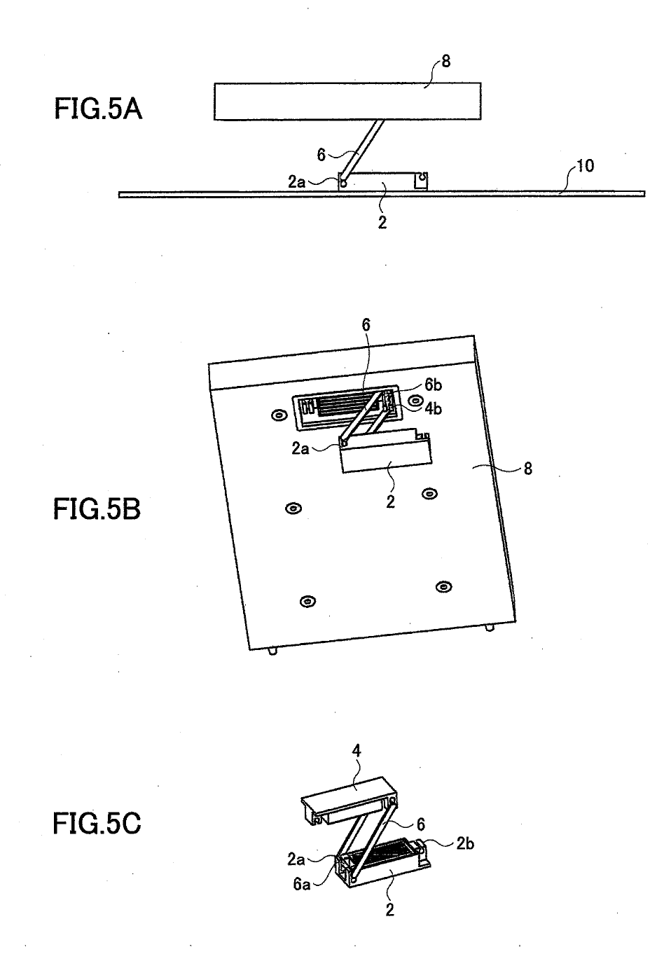

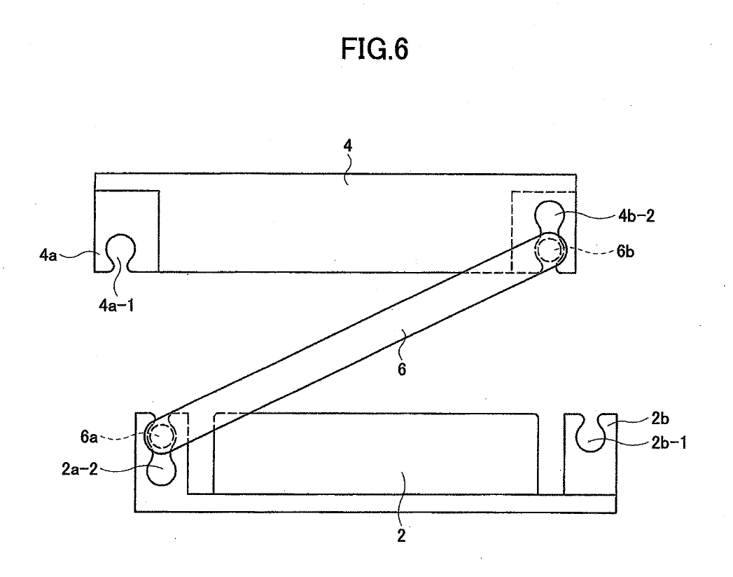

FIGS. 5A, 5B and 5C are views illustrating a state where the first engagement axis 6a is engaged with the fourth notch 2a-1 of the jack 2. FIGS. 5A, 5B and 5C are views corresponding to FIGS. 3A, 3B and 3C, respectively. Although the fourth notch 2a-1 and the fifth notch 2a-2 are continuously formed in the engagement part 2a of the jack 2 as illustrated in FIG. 2, the first engagement axis 6a is pressed into a position where the fourth notch 2a-1 lies and are not in engagement with the fifth notch 2a-2 in the state illustrated in FIGS. 5A, 5B and 5C. FIG. 6 is a side view illustrating positions of the first and second engagement axes 6a and 6b of the guide member 6 in the stated illustrated in FIGS. 5a, 5B and 5C. The first engagement axis 6a of the guide member 6 is engaged with the fourth notch 2a-1 of the jack 2, and the second engagement axis 6b is engaged with the second notch 4b-1 of the plug 4.

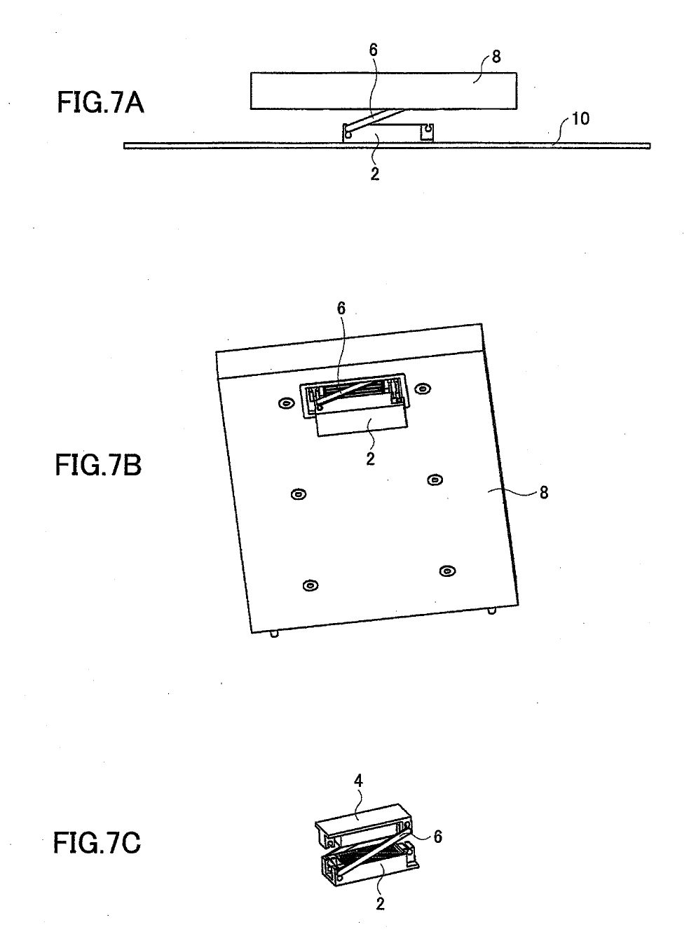

In the state illustrated in FIGS. 5A, 5B and 5C and FIG. 6, the jack 2 and the plug 4 (that is, the circuit board 10 and the module 8) are relatively movable (rotatable) with respect to the first engagement axis 6a and the second engagement axis 6b of the guide member 6 so that they move closer to each other. Because the jack 2 and the plug 4 (that is, the circuit board 10 and the module 8) are supported by the first and second engagement axes 6a and 6b, respectively, the jack 2 and the plug 4 (that is, the circuit board 10 and the module 8) can incline in a direction perpendicular to the first and second axes 6a and 6b, but cannot incline in other directions. Accordingly, the module 8 (plug 4) is movable toward the circuit board 10 (jack 2) while maintaining them parallel to each other as illustrated in FIGS. 7A, 7B and 7C.

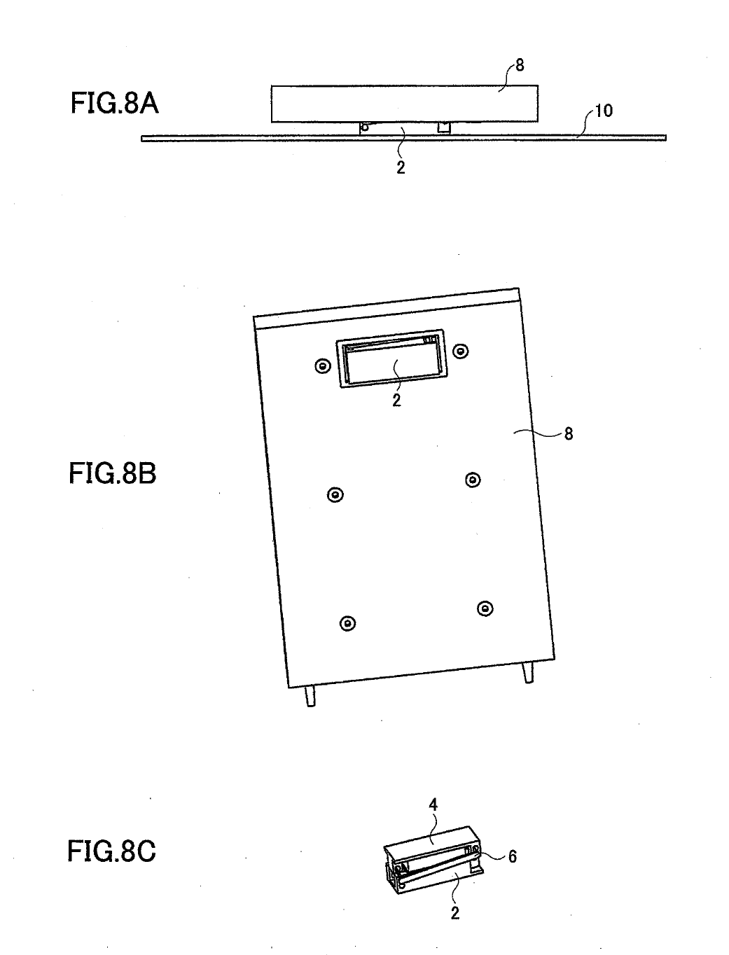

When the module 8 (plug 4) is further moved toward the circuit board 10 (jack 2) from the state illustrated in FIGS. 7A, 7B and 7C, the end surface of the plug 4 reaches the end surface of the jack 2 as illustrated in FIGS. 8A, 8B and 8C. In this state, the plug 4 is accurately positioned with respect to the jack 2. That is, because the plug 4 and the jack 2 are mutually supported by the first and second engagement axes 6a and 6b, the relative positional relationship in the connecting direction (the direction of allow A), when the plug 4 and the jack 2 is positioned parallel to each other, is determined depending on a distance between the plug 4 and the jack 2. Moreover, the plug and the jack are not able to move in directions other than the connecting direction, and also not able to incline.

Accordingly, if the distance between the first engagement axis 6a and the second engagement axis 6b is previously set to an appropriate value, the plug 4 can be accurately positioned at the connecting position with respect to the jack 2 in the position where the distance between the plug 4 and the jack 2 is zero. Such a state is illustrated in FIGS. 8A, 8B and 8C.

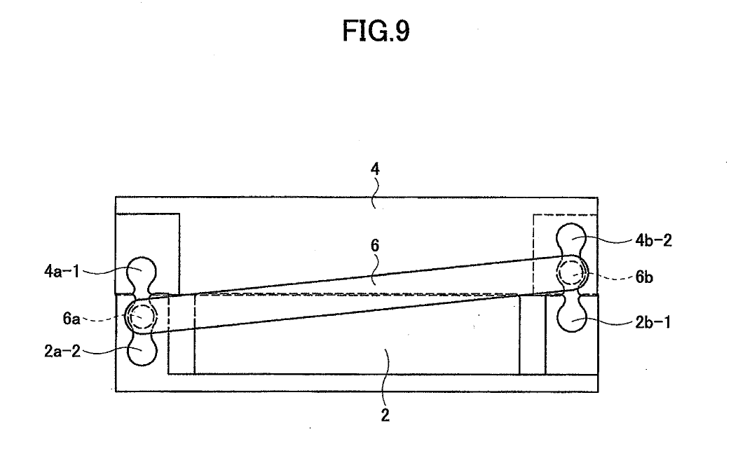

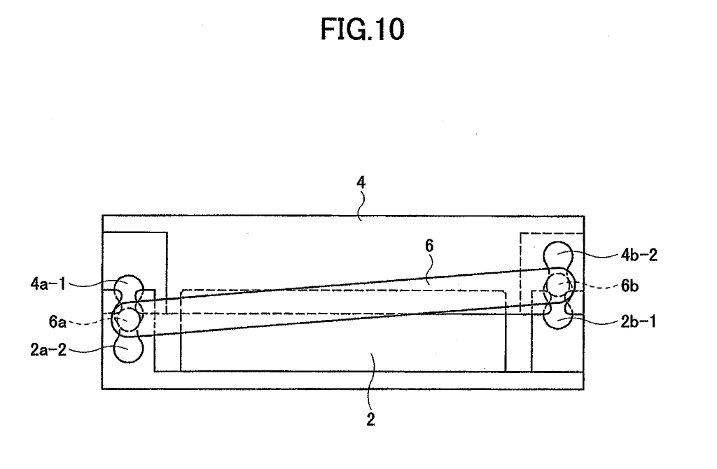

In the state illustrated in FIGS. 8A, 8B and 8C, the first engagement axis 6a of the guide member 6 is engaged with the fourth notch 2a-1 of the jack 2, and the second engagement axis 6b of the guide member 6 is merely engaged with the second notch 4b-1 of the plug 4. FIG. 9 is a side view illustrating positions of the first and second engagement axes 6a and 6b of the guide member 6 illustrated in FIGS. 8A, 8B and 8C. As mentioned above, the first engagement axis 6a of the guide member 6 is engaged with the fourth notch 2a-1 of the jack 2, and the second engagement axis 6b is engaged with the second notch 4b-1 of the plug 4.

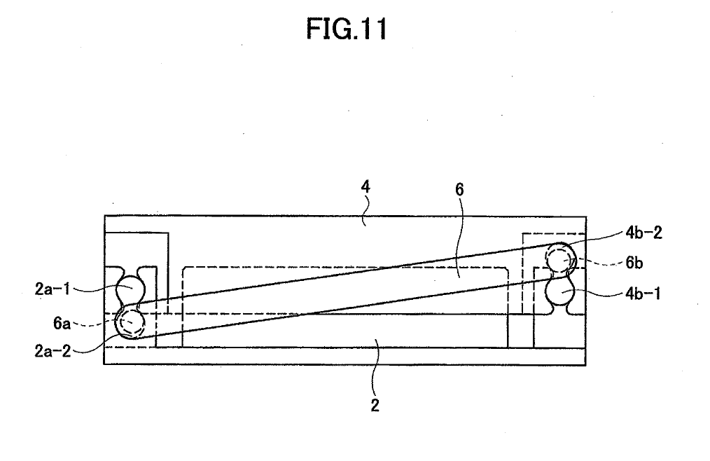

In order to insert and connect the plug 4 to the jack 2, plug 4 must be pressed into the jack 3. Thus, when the plug 4 is pressed into the jack 2 from the state illustrated in FIGS. 8A, 8B and 8C, the first engagement axis 6a of the guide member 6 is pressed by the engagement part 4a of the plug 4 and moves toward the fifth notch 2a-2 connected to the fourth notch 2a-1. Similarly, the second engagement axis 6b of the guide member 6 is pressed by the engagement part 2b of the jack 2 and moves toward the third notch 4b-2 connected to the second notch 4b-1. Then, as illustrated in FIG. 11, the first engagement axis 6a of the guide member 6 is pressed into and engaged with the fifth notch 2a-2 of the jack 2, and the second engagement axis 6b of the guide member 6 is pressed into and engaged with the third notch 4b-2 of the plug 4.

In the state illustrated in FIG. 11, the plug 4 is not completely inserted in the jack 2. That is, the plug 4 has not been pressed into the jack 2 by a distance corresponding to the size (diameter) of the first and second engagement axes 6a and 6b.

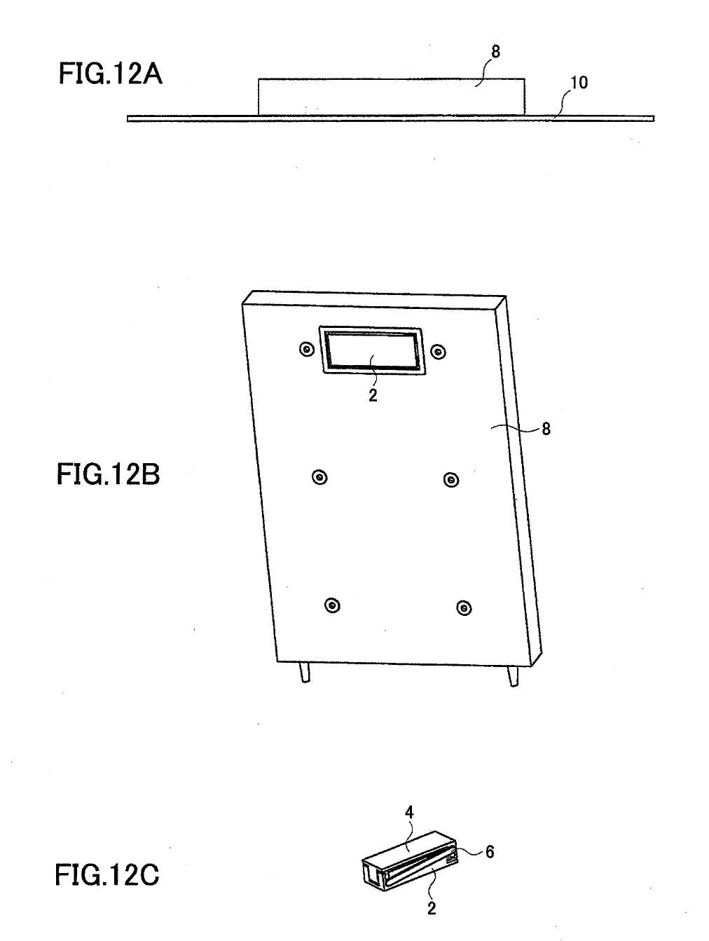

Thus, in order to completely insert the plug 4 into the jack 2, the first notch 4a-1 is provided in the engagement part 4a of the plug 4, and the sixth notch 2b-1 is provided in the engagement part 2b of the jack 2. That is, when the plug 4 is further pressed toward the jack 2 from the state where the first engagement axis 6a is pressed into the fifth notch 2a-2 and the second engagement axis 6b is pressed into the third notch 4b-2, the first notch 4a-1 of the engagement part 4a of the plug 4 moves downward and the first engagement axis 6a of the guide member 6 is pressed into and engaged with the first notch 4a-1. At the same time, the second engagement axis 6a of the guide member 6 moves downward, and is pressed into and engaged with the sixth notch 2b-1 of the engagement part 2b of the jack 2. Thereby, as illustrated in FIGS. 12A, 12B and 12C, it is set in a state where the plug 4 is completely inserted into the jack 2, and set in a state where the module 8 is connected to the circuit board 10.

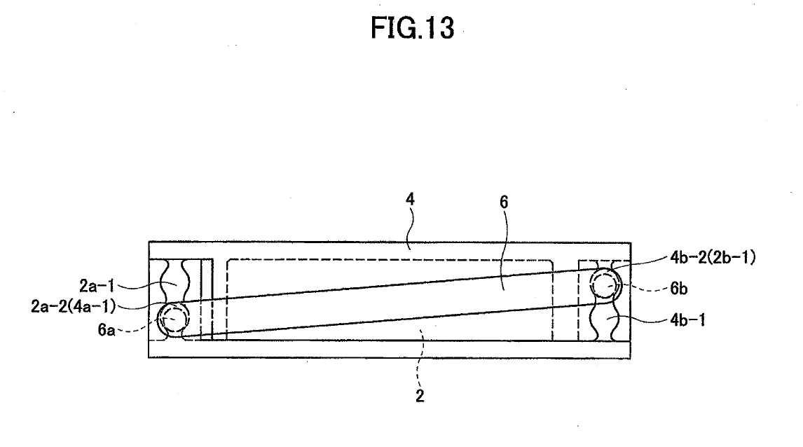

FIG. 13 is a view illustrating positions of the first and second engagement axes 6a and 6b of the guide member 6 in the state where the plug 4 is completely inserted in the jack 2. The first engagement axis 6a of the guide member 6 is pressed into and engaged with the fifth notch 2a-2 formed in a deep portion of the fourth notch 2a-1, and the second engagement axis 6b of the guide member 6 is pressed into and engaged with the third notch 4b-2 formed in a deep portion of the second notch 4b-1.

As mentioned above, according to the present embodiment, the plug 4 can be positioned accurately by guiding the plug 4 to the connecting position by coupling the jack 2 and the plug 4 using the guide member 6 and moving the plug 4 toward the jack 2. Because, the moving direction of the plug 4 with respect to the jack 2 is restricted by the guide member 6, the plug 4 can be inserted into the jack along the connecting direction of the connector. Moreover, because the connecting operation is performed after the guide member 6 is connected to both the jack 2 and the plug 4, a connection in a wrong direction (for example, a direction different by 90 degrees) can be prevented.

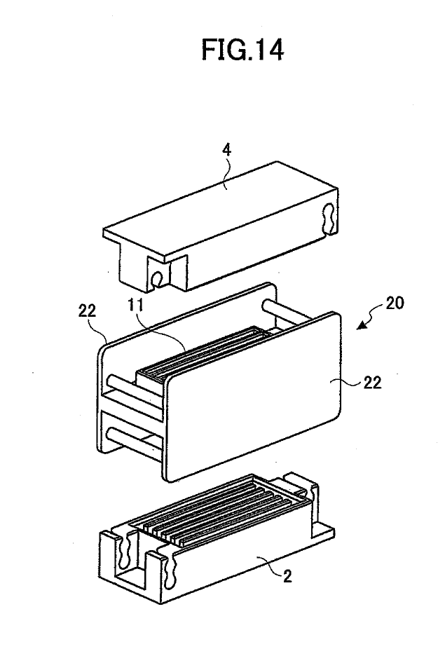

A description will be given of a connector according to a second embodiment. FIG. 14 is a perspective view of the connector according to the second embodiment. In FIG. 14, parts that are the same as the parts illustrated in FIG. 1 are given the same reference numerals, and descriptions thereof will be omitted.

The connector according to the second embodiment includes a jack 2, a plug 4 and a relay guide member 20. That is, the guide member 6 in the connector illustrated in FIG. 1 is replaced by the relay guide member 20. The relay guide member 20 has the same function to guide the insertion of the plug 4 into the jack 2 as the guide member 6. Because the relay guide member 20 has a predetermined thickness and is placed between the plug 4 and the jack 2, when the plug 4 is connected to the jack 2, the plug 4 separates from the jack 2 by a distance corresponding to the thickness of the relay guide member 20. Thereby, the distance between the plug 4 and the jack 2 can be set large when the plug 4 and the jack 2 are connected to each other. In a case where a component having a large height is arranged on the mount surface of the circuit board, the height of the connector can be increased, when the plug 4 and the jack 2 are connected, by using the relay guide member 20. Thus, a connection can be achieved by setting a distance between two circuit boards to be larger than the height of the component.

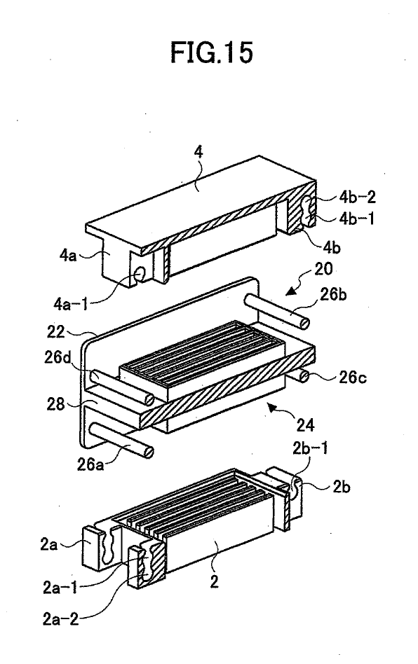

FIG. 15 is a cross-sectional perspective view of the connector illustrated in FIG. 14. The relay guide member 20 includes two side plates 22, a relay connection part 24 arranged between the side plates 22, and four engagement axes extending between the side plates 22, which are a first engagement axis 26d, a second engagement axis 26b, a third engagement axis 26a and a fourth engagement axis 26c.

Electrode terminals are arranged inside the relay connection part 24. An upper portion of the relay connection part 24 is configured to fit to the plug 4 and a lower portion of the relay connection part 24 is configured to fit to the jack 2. Accordingly, when the plug 4 is connected to the upper portion of the relay connection part 24 and the lower portion of the relay connection part 24 is connected to the jack 2, the electrode terminals of the plug 4 are electrically connected to the electrode terminals of the jack 2 through relay electrode terminals provided inside the relay connection part 24, thereby serving as a connector. That is, the upper portion of the relay connection part 24 has the same connection structure as the jack 2 and the lower portion of the relay connection part 24 has the same connection structure as the plug 4.

The relay connection part 24 is attached to a support plate 28 extending in the middle portion between the two side plates 22. The first engagement axis 26d is provided in the vicinity of an end of the relay connection part 24 above the support plate 28. The first engagement axis 26d is supported by the two side plates 22, and extends between the side plates 22. The second engagement axis 26b is provided in the vicinity of the other end of the relay connection part 24 above the support plate 28. The second engagement axis 26b is supported by the two side plates 22, and extends between the side plates 22. The third engagement axis 26a is provided in the vicinity of an end of the relay connection part 24 under the support plate 28. The third engagement axis 26a is supported by the two side plates 22 and extends between the side plates 22. The fourth engagement axis 26c is provided in the vicinity of the other end of the relay connection part 24 under the support plate 28. The fourth engagement axis 26c is supported by the two side plates 22 and extends between the side plates 22.

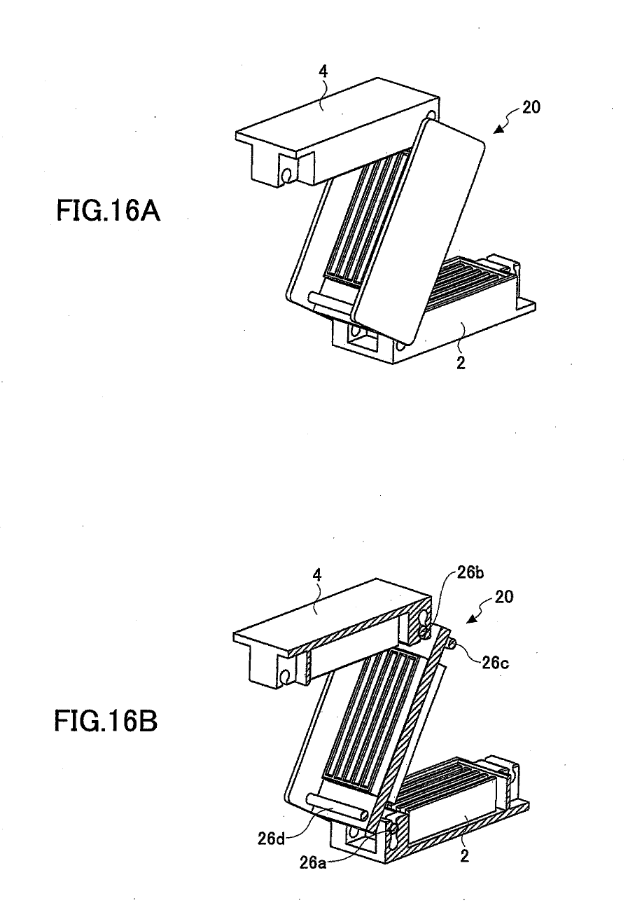

A description is given below of an operation of connecting the plug 4 to the jack 2 using the relay connection part 24. First, as illustrated in FIGS. 16A and 16B, the second engagement axis 26b of the relay guide member 20 is pressed into and engaged with the second notch 4b-1 of the engagement part 4b of the plug 4. Then, the third engagement axis 26a of the relay guide member 20 is pressed into and engaged with the fourth notch 2a-1 of the engagement part 2a of the jack 2. This operation is the same as the operation illustrated in FIGS. 4A, 4B and 4C and FIGS. 5A, 5B and 5C in the first embodiment.

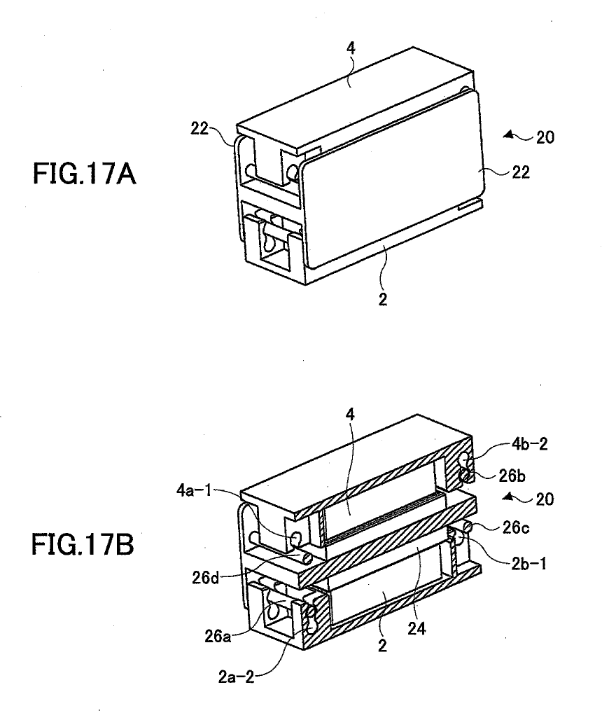

Then, as illustrated in FIGS. 17A and 17B, the relay connection part 20 is stacked on the jack 2 and the plug 4 is stacked on the plug 4. At this time, because the relay guide member 20 is rotatably supported by the third engagement axis 26a with respect to the jack 2, the jack 2 can be positioned at a predetermined position by merely rotating the relay guide member 20 with respect to the jack 2 about the third engagement axis 26a as a center of rotation. That is, the relay guide member 20 is automatically guided to the connecting position to the jack 2. Similarly, because the plug 4 is rotatably supported by the second engagement axis 26b with respect to the relay guide member 20, the relay guide member 20 can be positioned at a predetermined position by merely rotating the plug 4 with respect to the relay guide member 20 about the second engagement axis 26b as a center of rotation. That is, the plug 4 is automatically guided to the connecting position to the relay guide member 20.

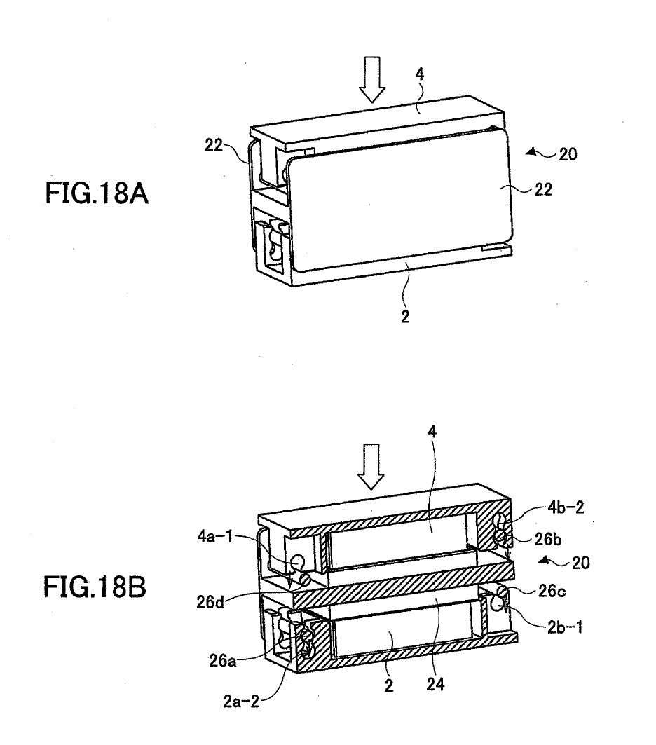

After the plug 4 and the relay guide member 20 are arranged on the jack 2 in a stacked state, the plug 4 is pressed toward the jack 2 as illustrated in FIGS. 18A and 18B. When the plug 4 is pressed, the first axis 26d of the relay guide member 20 is pressed into the first notch 4a-1 of the engagement part 4 of the plug 4, and simultaneously, the second axis 26b of the relay guide member 20 is pressed into the third notch 4b-2 from the second notch 4b-1 of the engagement part 4b of the plug 4. Thereby, the plug 4 is inserted into the relay connection part 24 of the relay guide member 20, and the connection terminals inside the plug 4 are connected to the connection terminals of the relay connection part 24.

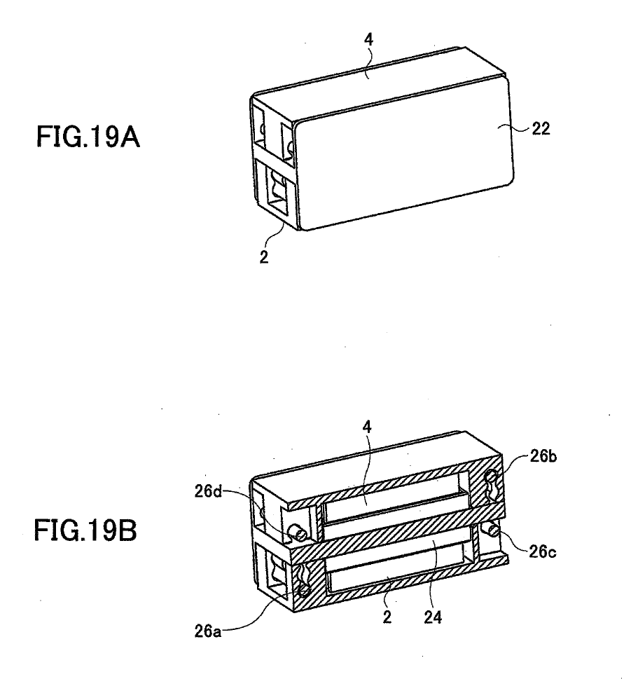

When the plug 4 is pressed further, the relay guide member 20 is pressed against the jack 2. Thereby, fourth engagement axis 26c of the relay guide member 20 is pressed into the sixth notch 2b-1 of the engagement part 2b of the jack 2, and the third engagement axis 26a of the relay guide member 20 is pressed into the fifth notch 2a-2 from the fourth notch 2a-1 of the engagement part 2a of the jack 2. Thereby, as illustrated in FIGS. 19A and 19B, the relay connection part 24 of the relay guide member 20 is inserted into the jack 2, and the connection terminal inside the relay connection part 24 are connected to the connection terminals of the jack 2. According to the above mentioned operation, the plug 4 is connected to the jack 2 through the relay connection part 24.

As mentioned above, according to the present embodiment, the plug 4 can be positioned accurately by guiding the relay guide member 20 to the connecting position of the jack 2 by moving the plug 4 toward the jack 2 after coupling the jack 2 and the plug 4 through the relay guide member 20, and the relay guide member 20 can be positioned accurately by guiding the relay guide member 20 to the connecting position of the jack 2. Because the moving direction of the plug 4 with respect to the relay guide member 20 and the moving direction of the relay guide member 20 with respect to the jack 2 are restricted, the plug 4 can be inserted into the relay guide member 20 along the connecting direction of the connector and the relay guide member 20 can be inserted into the jack 2.

Because the plug 4 is connected to the jack 2 through the relay guide member 20, the height of the connector is increased by a height corresponding to the thickness of the relay connection part 24 of the relay guide member 20. Therefore, the height of the connector can be increased by using the relay guide member 20. In addition, the thickness of the relay connection part 24 of the relay guide member 20 can be set to an arbitrary thickness, and may be previously set to be a desired height.

All examples and conditional language recited herein are intended for pedagogical purposes to aid the reader in understanding the principles of the invention and the concepts contributed by the inventor to furthering the art, and are to be construed a being without limitation to such specifically recited examples and conditions, nor does the organization of such examples in the specification relates to a showing of the superiority and inferiority of the invention. Although the embodiment(s) of the present invention (s) has(have) been described in detail, it should be understood that the various changes, substitutions, and alterations could be made hereto without departing from the spirit and scope of the invention.

What is claimed is:

1. A connector, comprising:
a plug including a plurality of plug-side electrode terminals arranged therein, the plug having a first engagement part on one end side in a direction of arrangement of the plug-side electrode terminals and a second engagement part on the other end side; and
a jack including a plurality of jack-side electrode terminals arranged therein, the jack-side electrode terminals configured to be connected to the plug-side electrode terminals, the jack having a third engagement part on one end side in a direction of arrangement of the jack-side electrode terminals and a fourth engagement part on the other end side; and
a guide member having a fifth engagement part and a sixth engagement part, the fifth engagement part configured to engage with the first engagement part of the plug and the third engagement part of the jack, the sixth engagement part configured to engage with the second engagement part of the plug and the fourth engagement part of the jack.

2. The connector as claimed in claim 1, wherein the fifth engagement part of the guide member includes a first engagement axis, and the sixth engagement part includes a second engagement axis parallel to the first engagement axis.

3. The connector as claimed in claim 2, wherein
the third engagement part of the jack includes two engagement parts separated from each other in a direction perpendicular to the direction of arrangement of the jack-side electrode terminals;
the second engagement part of the plug includes two engagement parts separated from each other in a direction perpendicular to the direction of arrangement of the plug-side electrode terminals; and
in a state where the plug is connected to the jack, the first engagement part of the plug is positioned between the two engagement parts of the jack, and the fourth engagement part of the jack is positioned between the two engagement parts of the plug.

4. The connector as claimed in claim 3, wherein
the first engagement part of the plug includes a first notch configured to receive and engage with the first engagement axis;
the second engagement part of the plug includes a second notch configured to receive and engage with the second engagement axis and a third notch formed to connect to the second notch;
the third engagement part of the jack includes a fourth notch configured to receive and engage with the first engagement axis and a fifth notch formed to connect to the fourth notch;
the fourth engagement part of the jack includes a sixth notch configured to receive and engage with the second engagement axis; and
in the state where the plug is connected to the jack, the first engagement axis engages with the first notch and the fifth notch, and the second engagement axis engages with the third notch and the sixth notch.

5. The connector as claimed in claim 1, wherein
the guide member includes a relay connection part arranged between the fifth engagement part and the sixth engagement part;
the relay connection part includes a plurality of relay electrode terminals configured to be connected to the first electrode terminals of the plug and second electrode terminals of the jack, respectively;
the plug is configured to be connected to one end side of the relay connection part and the jack is configured to be connected to the other end side of the relay connection part;
the fifth engagement part of the guide member includes a first engagement axis and a third engagement axis parallel to the first engagement axis, the first engagement axis extending in a direction perpendicular to an extending direction of the relay electrode terminals; and
the sixth engagement part of the guide member includes a second engagement axis and a fourth engagement axis parallel to the second engagement axis, the fourth engagement axis extending in a direction perpendicular to the extending direction of the relay electrode terminals.

6. The connector as claimed in claim 5, wherein
the third engagement part of the jack includes two engagement parts separated from each other in a direction perpendicular to the direction of arrangement of the jack-side electrode terminals;
the second engagement part of the plug includes two engagement parts separated from each other in a direction perpendicular to the direction of arrangement of the plug-side electrode terminals; and
in a state where the plug is connected to the relay connection part and the relay connection part is connected to the jack, the first engagement part of the plug is positioned between the two engagement parts of the jack, and the fourth engagement part of the jack is positioned between the two engagement parts of the plug.

7. The connector as claimed in claim 6, wherein
the first engagement part of the plug includes a first notch configured to receive and engage with the first engagement axis;
the second engagement part of the plug includes a second notch configured to receive and engage with the second engagement axis and a third notch formed to connect to the second notch;
the third engagement'part of the jack includes a fourth notch configured to receive and engage with the first engagement axis and a fifth notch formed to connect to the fourth notch;
the fourth engagement part of the jack includes a sixth notch configured to receive and engage with the second engagement axis; and
in a state where the plug is connected to the relay connection part and the relay connection part is connected to the jack, the first engagement axis engages with the first notch and the fifth notch, the second engagement axis engages with the third notch, the third engagement axis engages with the fifth notch, and the fourth engagement axis engages with the sixth notch.

8. A connecting method of the connector as claimed in claim 4, comprising:
engaging the second engagement axis of the guide member with the second notch of the plug, and engaging the first engagement axis of the guide member with the fourth notch of the jack;
moving the plug toward the jack to a connecting position by rotating the guide member about the first engagement axis and the second engagement axis with respect to the plug and the jack; and
after the plug reaches the connecting position, pressing the plug toward the jack and inserting the plug into the jack so as to cause the first engagement axis of the guide member to engage with the first notch of the plug and the fifth notch of the jack and the second engagement axis of the guide member to engage with the fourth notch of the jack and the third notch of the plug.

9. A connecting method of the connector as claimed in claim 7, comprising:
engaging the second engagement axis of the relay guide member with the second notch of the plug, and engaging the third engagement axis of the relay guide member with the fourth notch of the jack;
moving the plug and the relay guide member toward the jack to a connecting position by rotating the relay guide member about the first engagement axis and the second engagement axis with respect to the plug and the jack; and
after the plug and the relay guide member reach the connecting position, pressing the plug toward the jack through the relay guide member and inserting the plug into the relay connection part of relay connection guide and the relay connection part into the jack so as to cause the first engagement axis of the relay guide member to engage with the first notch of the plug, the third engagement axis of the relay guide part to engage with the fifth notch of the jack, the fourth engagement axis of the relay guide member to engage with the third notch of the plug, and the forth engagement axis of the relay guide member to engage with the sixth notch of the jack.
